(19) United States
(12) Patent Application Publication
(10) Pub. No.: US 2024/0120549 A1
(43) Pub. Date: Apr. 11, 2024

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/522,833

(22) Filed: Nov. 29, 2023

Related U.S. Application Data
(63) Continuation of application No. PCT/JP2021/021442, filed on Jun. 4, 2021.

(51) Int. Cl. H01M 10/0569; H01M 10/0568

(52) U.S. Cl. CPC H01M 10/0569; H01M 10/0568; H01M 10/052

(57) ABSTRACT

The purpose of the present invention is to provide a lithium secondary battery having a high energy density and an excellent cycle characteristic. The present invention relates to a lithium secondary battery including a positive electrode, a negative electrode not having a negative-electrode active material, and an electrolyte solution, in which the electrolyte solution contains a lithium salt and a cyclic fluorine compound having a cyclic hydrocarbon skeleton in which at least one hydrogen atom is substituted with a fluorine atom.

### CROSS-REFERENCE TO RELATED APPLICATION

This application is a continuation of International Application PCT/JP2021/021442, entitled “LITHIUM SECONDARY BATTERY”, filed on Jun. 4, 2021, the entire contents of which are incorporated by reference.

### TECHNICAL FIELD

The present invention relates to a lithium secondary battery.

### BACKGROUND ART

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which perform charge/discharge by transferring lithium ions between a positive electrode and a negative electrode are known to exhibit a high voltage and a high energy density. As typical lithium secondary batteries, lithium-ion secondary batteries (LIB) which have a positive electrode and a negative electrode having an active material capable of retaining lithium element and perform charge/discharge by delivering or receiving lithium ions between a positive-electrode active material and a negative-electrode active material are known.

For the purpose of realizing high energy density, a lithium secondary battery (lithium metal battery; LMB) that lithium metal is used as the negative-electrode active material, instead of a material into which the lithium ion can be inserted, such as a carbon material, has been developed. For example, PCT Japanese Translation Patent Publication No. 2006-500755 discloses a rechargeable battery using, as a negative electrode, an electrode based on lithium metal.

For the purpose of further improving high energy density and improving productivity, or the like, a lithium secondary battery using a negative electrode that does not have a negative-electrode active material such as the carbon material and the lithium metal has been developed. For example, PCT Japanese Translation Patent Publication No. 2019-505971 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. PCT Japanese Translation Patent Publication No. 2019-505971 discloses that such a lithium secondary battery shows the possibility of providing a lithium secondary battery which has overcome the problem due to the reactivity of the lithium metal and the problem caused during assembly process and therefore has improved performance and service life.

### SUMMARY

### Technical Problem

As a result of detailed investigation of conventional batteries including those disclosed in PCT Japanese Translation Patent Publication No. 2006-500755 and PCT Japanese Translation Patent Publication No. 2019-505971, the present inventors have found that at least either one of their energy density and cycle characteristic is not sufficient.

For example, in the lithium secondary battery that includes a negative electrode containing the negative-electrode active material, due to the volume or mass occupied by the negative-electrode active material, it is difficult to sufficiently increase the energy density. In addition, even in conventional anode-free lithium secondary batteries, that includes a negative electrode not containing a negative-electrode active material, due to repeated charge/discharge, a dendrite-like lithium metal is likely to be formed on a surface of the negative electrode, which is likely to cause short circuiting and a decrease in capacity, resulting in insufficient cycle characteristic.

The present invention has been made in consideration of the aforesaid problems and a purpose is to provide a lithium secondary battery having a high energy density and excellent in cycle characteristic.

### Solution to Problem

The lithium secondary battery according to one embodiment of the present invention includes a positive electrode, a negative electrode not having a negative-electrode active material, and an electrolyte solution, in which the electrolyte solution contains a lithium salt and a cyclic fluorine compound having a cyclic hydrocarbon skeleton in which at least one hydrogen atom is substituted with a fluorine atom.

Such a lithium secondary battery equipped with a negative electrode not having a negative-electrode active material has a high energy density because a lithium metal precipitates on the surface of the negative electrode and charge/discharge are performed by depositing lithium metal on the surface of the negative electrode and electrolytically dissolving the deposited lithium.

In addition, the present inventors have found that a lithium secondary battery containing a cyclic fluorine compound having a cyclic hydrocarbon skeleton in which at least one hydrogen atom is substituted with a fluorine atom has excellent cycle characteristic. As a factor for this, it is presumed that, in such a mode of containing the cyclic fluorine compound, a solid electrolyte interfacial layer (hereinafter, also referred to as “SEI layer”) is easily formed on a surface of the negative electrode, but the factor is not limited thereto. Because the SEI layer has ionic conductivity, reactivity of lithium deposition reaction on the surface of the negative electrode, on which the SEI layer is formed, tends to be uniform in a plane direction of the surface of the negative electrode. Further, the present inventors have found that, in the mode, compatibility between solvents in the electrolyte solution is improved, and the electrolyte solution maintains its formulation stably even when the battery is repeatedly charged/discharged. This is presumed to be because the cyclic fluorine compound tends to be more polar than a chain-like fluorine compound, and tends to be evenly distributed in the electrolyte solution. It is presumed that, by using the electrolyte solution in which the cyclic fluorine compound is evenly distributed, for example, the cycle characteristic of the battery are improved further due to the aforesaid factor. Therefore, in the aforesaid lithium secondary battery, a growth of a lithium metal into dendrite form on the negative electrode is suppressed even when the battery is repeatedly charged/discharged, and the cycle characteristic is excellent. The factor that facilitates the formation of the SEI layer by containing the fluorine compound, and the factor that the compatibility is improved by containing the cyclic fluorine compound are not particularly limited thereto.

Further, the present inventors have also found that, by containing the aforesaid cyclic fluorine compound in the electrolyte solution of the lithium secondary battery, a volume expansion ratio of the battery can be smaller when the battery is repeatedly charged/discharged. Since the cyclic fluorine compound tends to be more polar than the chain-like fluorine compound, it is presumed that a boiling point is high and a vapor pressure is low. Accordingly, the lithium secondary battery of the present invention tends to be also excellent in safety because the volume expansion ratio of the battery is suppressed.

In the lithium secondary battery according to the one embodiment of the present invention, it is preferable that the aforesaid cyclic fluorine compound has polarity. In such a mode, since the compatibility between solvents in the electrolyte solution is likely to be improved further and the volume expansion ratio of the battery is likely to be suppressed further, the lithium secondary battery tends to have even more excellent cycle characteristic and safety.

In the lithium secondary battery according to the one embodiment of the present invention, it is preferable that, in the aforesaid cyclic fluorine compound, a ratio (F/(F+H)) of a number (F) of fluorine atoms to a total number (F+H) of fluorine atoms and hydrogen atoms is 0.20 or more and 1.0 or less. In such a mode, since properties of the SEI layer tend to be preferable, the cycle characteristic of the lithium secondary battery tends to be even more excellent.

In the lithium secondary battery according to the one embodiment of the present invention, it is preferable that the number of carbon atoms constituting the aforesaid cyclic hydrocarbon skeleton is 4 or more and 15 or fewer. In such a mode, since the compatibility in the electrolyte solution is likely to be improved further and the volume expansion ratio of the battery is likely to be suppressed further, the lithium secondary battery tends to have even more excellent cycle characteristic and safety.

In the lithium secondary battery according to the one embodiment of the present invention, it is preferable that the aforesaid electrolyte solution contains LiN(SO2F)2 as the lithium salt. In such a mode, the cycle characteristic of the lithium secondary battery tends to be even more excellent.

In the lithium secondary battery according to the one embodiment of the present invention, it is preferable that a content of the aforesaid cyclic fluorine compound is 10 vol. % or more and 90 vol. % or less based on a total amount of solvent components in the aforesaid electrolyte solution. In such a mode, the lithium secondary battery tends to have even more excellent cycle characteristic and safety.

In the lithium secondary battery according to the one embodiment of the present invention, it is preferable that the aforesaid electrolyte solution further contains an ether compound not having a fluorine atom. In such a mode, since solubility of the lithium salt in the electrolyte solution of the lithium secondary battery is improved, ionic conductivity in the electrolyte solution is improved and the lithium secondary battery tends to have excellent cycle characteristic.

In the lithium secondary battery according to the one embodiment of the present invention, it is preferable that the aforesaid ether compound is a compound including 2 or more and 5 or fewer ether bonds. In such a mode, the solubility of an electrolyte in the electrolyte solution is improved, and the lithium secondary battery tends to have even more excellent cycle characteristic.

In the lithium secondary battery according to the one embodiment of the present invention, it is preferable that a content of the aforesaid ether compound is 10 vol. % or more and 70 vol. % or less based on a total amount of solvent components in the aforesaid electrolyte solution. In such a mode, the solubility of an electrolyte in the electrolyte solution is improved, and the lithium secondary battery tends to have even more excellent cycle characteristic.

In the lithium secondary battery according to the one embodiment of the present invention, it is preferable that the aforesaid electrolyte solution further contains a chain-like fluorine compound having at least one of a monovalent group represented by Formula (A) or a monovalent group represented by Formula (B). In such a mode, the lithium secondary battery tends to have even more excellent cycle characteristic.

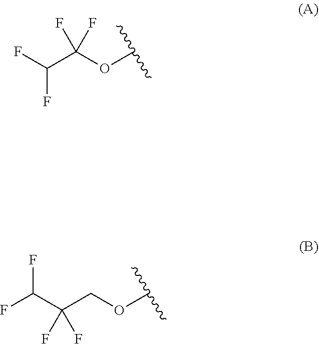

In the formulae, a wavy line represents a bonding site in the monovalent group.

In the lithium secondary battery according to the one embodiment of the present invention, it is preferable that a content of the aforesaid chain-like fluorine compound is 10 vol. % or more and 85 vol. % or less based on the total amount of solvent components in the aforesaid electrolyte solution. In such a mode, the lithium secondary battery tends to have even more excellent cycle characteristic.

In the lithium secondary battery according to the one embodiment of the present invention, it is preferable that the aforesaid cyclic hydrocarbon skeleton is a saturated cyclic hydrocarbon skeleton. In such a mode, the lithium secondary battery tends to have even more excellent cycle characteristic.

In the lithium secondary battery according to the one embodiment of the present invention, it is preferable that, in the aforesaid cyclic fluorine compound, a ratio (F/(F+H)) of a number (F) of fluorine atoms to a total number (F+H) of fluorine atoms and hydrogen atoms is 0.7 or more and 1.0 or less, and a number of carbon atoms constituting the aforesaid cyclic hydrocarbon skeleton is 5 or 6. In such a mode, the lithium secondary battery tends to have even more excellent cycle characteristic and safety.

### Effect of Invention

The present invention makes it possible to provide a lithium secondary battery having a high energy density and an excellent cycle characteristic.

### BRIEF DESCRIPTION OF DRAWINGS

FIG. 1 is a schematic cross-sectional view of a lithium secondary battery according to the embodiment of the present invention.

FIG. 2 is a schematic cross-sectional view of the use of the lithium secondary battery according to the embodiment of the present invention.

FIG. 3 illustrates a table of examples of the aforesaid cyclic fluorine compound.

FIG. 4 illustrates a table of examples of the aforesaid first chain-like fluorine compound and the aforesaid second chain-like fluorine compound.

FIG. 5 illustrates a table of examples of the ether co-solvent.

FIG. 6 illustrates a table of electrolyte solutions and characteristics.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

Lithium Secondary Battery

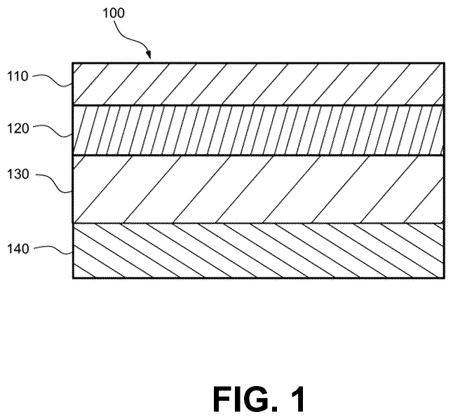

FIG. 1 is a schematic cross-sectional view of the lithium secondary battery according to the present embodiment. As shown in FIG. 1, a lithium secondary battery 100 of the present embodiment includes a positive electrode 120, a negative electrode 140 not having a negative-electrode active material, a separator 130 placed between the positive electrode 120 and the negative electrode 140, and an electrolyte solution that is not shown in FIG. 1. The positive electrode 120 has a positive electrode current collector 110 on the surface thereof opposite to the surface facing the separator 130.

Hereinafter, each configuration of the lithium secondary battery 100 will be described.

Negative Electrode

The negative electrode 140 does not have a negative-electrode active material. The “negative-electrode active material” as used herein is a substance that causes an electrode reaction, that is, an oxidation reaction and a reduction reaction at the negative electrode. Specifically, examples of the negative-electrode active material in the present embodiment include lithium metal and a host material for a lithium element (lithium ions or lithium metal). The host material for the lithium element means a material provided to retain the lithium ions or the lithium metal in the negative electrode. Such a retaining mechanism is not particularly limited, and examples thereof include intercalation, alloying, and occlusion of metal clusters. Intercalation is typically used.

In the lithium secondary battery of the present embodiment, because the negative electrode does not have a negative-electrode active material before initial charging of the battery, charge/discharge are performed by depositing lithium metal on the negative electrode and electrolytically dissolving the deposited lithium metal. Therefore, in the lithium secondary battery of the present embodiment, an occupation volume of the negative-electrode active material and a mass of the negative-electrode active material decreases as compared with a lithium secondary battery containing the negative-electrode active material, and the volume and mass of the entire battery are small, so that the energy density is high in principle.

In the lithium secondary battery 100 of the present embodiment, the negative electrode 140 does not have a negative-electrode active material before initial charging of the battery, a lithium metal is deposited on the negative electrode when the battery is charged, and the deposited lithium metal is electrolytically dissolved when the battery is discharged. Therefore, in the lithium secondary battery of the present embodiment, the negative electrode acts as a negative electrode current collector.

In a case where the lithium secondary battery 100 of the present embodiment is compared with a lithium ion battery (LIB) and a lithium metal battery (LMB), the following points are different.

In the lithium ion battery (LIB), a negative electrode has a host material for a lithium element (lithium ions or lithium metal), this material is filled with the lithium element when the battery is charged, and the host material releases the lithium element, thereby discharging the battery. The LIB is different from the lithium secondary battery 100 of the present embodiment in that the negative electrode has the host material for the lithium element.

The lithium metal battery (LMB) is produced by using, as a negative electrode, an electrode having lithium metal on its surface or a single lithium metal. That is, the LMB is different from the lithium secondary battery 100 of the present embodiment in that the negative electrode has the lithium metal, that is the negative-electrode active material, immediately after assembling the battery, that is, before initial charging of the battery. The LMB uses the electrode containing lithium metal having high flammability and reactivity in its production. However, because the lithium secondary battery 100 of the present embodiment uses the negative electrode not having lithium metal, the lithium secondary battery 100 of the present embodiment is more safe and productive.

The negative electrode “not having a negative-electrode active material” as used herein means the negative electrode 140 does not have the negative-electrode active material or does not substantially has the negative-electrode active material. The fact that the negative electrode 140 does not substantially has the negative-electrode active material means the content of the negative-electrode active material in the negative electrode 140 is 10 mass % or less based on the total amount of the negative electrode. The content of the negative-electrode active material in the negative electrode is preferably 5.0 mass % or less and it may be 1.0 mass % or less, 0.1 mass % or less, or 0.0 mass % or less, each based on the total amount of the negative electrode 140. Since the negative electrode 140 does not have the negative-electrode active material or the content of the negative-electrode active material in the negative electrode 140 falls within the aforesaid range, the energy density of the lithium secondary battery 100 is high.

The “before initial charging” of the battery as used herein means a state from the time when the battery is assembled to the time when the battery is first charged. In addition, “at the end of discharging” of the battery means a state in which the battery voltage is 1.0 V or more and 3.8 V or less, preferably 1.0 V or more and 3.0 V or less.

The “lithium secondary battery including a negative electrode not having a negative-electrode active material” as used herein means the negative electrode 140 does not have the negative-electrode active material before initial charging of the battery. Therefore, the phrase “negative electrode not having a negative-electrode active material” may be replaced by “negative electrode not having a negative-electrode active material before initial charging of the battery”, “negative electrode that does not have a negative-electrode active material other than lithium metal regardless of the state of charging of the battery and does not have the lithium metal before initial charging”, “negative electrode current collector not having lithium metal before initial charging”, or the like. In addition, the “lithium secondary battery including a negative electrode not having a negative-electrode active material” may be replaced by an anode-free lithium battery, a zero-anode lithium battery, or an anode-less lithium battery.

In the negative electrode 140 of the present embodiment, regardless of the state of charging of the battery, the content of the negative-electrode active material other than lithium metal may be 10 mass % or less based on the total amount of the negative electrode, preferably 5.0 mass % or less, and may be 1.0 mass % or less, 0.1 mass % or less, 0.0 mass % or less, or 0 mass %.

In addition, in the negative electrode 140 of the present embodiment, the content of lithium metal before initial charging may be 10 mass % or less based on the total amount of the negative electrode, preferably 5.0 mass % or less, and may be 1.0 mass % or less, 0.1 mass % or less, 0.0 mass % or less, or 0 mass %.

In the lithium secondary battery 100 of the present embodiment, in a case where the battery voltage is 1.0 V or more and 3.5 V or less, the content of lithium metal may be 10 mass % or less based on the total amount of the negative electrode 140 (preferably 5.0 mass % or less, and may be 1.0 mass % or less); in a case where the battery voltage is 1.0 V or more and 3.0 V or less, the content of lithium metal may be 10 mass % or less based on the total amount of the negative electrode 140 (preferably 5.0 mass % or less, and may be 1.0 mass % or less); or in a case where the battery voltage is 1.0 V or more and 2.5 V or less, the content of lithium metal may be 10 mass % or less based on the total amount of the negative electrode 140 (preferably 5.0 mass % or less, and may be 1.0 mass % or less).

In the lithium secondary battery 100 of the present embodiment, a ratio M3.0/M4.2 of a mass M3.0 of lithium metal deposited on the negative electrode in a state in which the battery voltage is 3.0 V to a mass M4.2 of lithium metal deposited on the negative electrode in a state in which the battery voltage is 4.2 V is preferably 40% or less, more preferably 38% or less, and still more preferably 35% or less. The ratio M3.0/M4.2 may be 1.0% or more, 2.0% or more, 3.0% or more, or 4.0% or more.

Examples of the negative-electrode active material of the present embodiment include lithium metal, alloys containing lithium metal, carbon-based substances, metal oxides, metals alloyed with lithium, and alloys containing the metals. The carbon-based material is not particularly limited, and examples thereof include graphene, graphite, hard carbon, mesoporous carbon, carbon nanotube, and carbon nanohorn. The metal oxide is not particularly limited, and examples thereof include titanium oxide-based compounds, tin oxide-based compounds, and cobalt oxide-based compounds. Examples of the aforesaid metals alloyed with lithium include silicon, germanium, tin, lead, aluminum, and gallium.

The negative electrode 140 of the present embodiment is not particularly limited insofar as it does not have a negative-electrode active material and can be used as a current collector. Examples thereof include at least one selected from the group consisting of metals such as Cu, Ni, Ti, Fe, and other metals that do not react with Li, alloys of these metals, and stainless steel (SUS), and preferred examples thereof include at least one selected from the group consisting of Cu, Ni, alloys of these metals, and stainless steel (SUS). When this negative electrode is used, the energy density and the productivity of the battery tend to be improved further. When a SUS is used as the negative electrode, a variety of conventionally known SUSs can be used as its kind. One or more of the negative electrode materials may be used either singly or in combination. The term “metal that does not react with Li” as used herein means a metal which does not form an alloy under the operation conditions of the lithium secondary battery, reacting with a lithium ion or a lithium metal.

The capacity of the negative electrode 140 is sufficiently small relative to the capacity of the positive electrode 120 and it may be, for example, 20% or less, 15% or less, 10% or less, or 5% or less. Each capacity of the positive electrode 120 and the negative electrode 140 can be measured by a conventionally known method.

The average thickness of the negative electrode 140 is preferably 4 μm or more and 20 μm or less, more preferably 5 μm or more and 18 μm or less, and still more preferably 6 μm or more and 15 μm or less. In such a mode, since the occupation volume of the negative electrode 140 in the lithium secondary battery 100 decreases, the lithium secondary battery 100 has a more improved energy density.

In the present embodiment, the thickness can be measured using a known measurement method. For example, it can be measured by cutting the lithium secondary battery in a thickness direction and observing the exposed cut section by a scanning electron microscope (SEM) or a transmission electron microscope (TEM). The “average thickness” and “thickness” in the present embodiment are found by calculating an arithmetic mean of the thicknesses measured 3 times or more and preferably 5 times or more.

Electrolyte Solution

The electrolyte solution contains an electrolyte and a solvent. It is a solution having ionic conductivity and serves as a conductive path of a lithium ion. The separator 130 may be wetted with the electrolyte solution or the electrolyte solution may be encapsulated with a stacked body of the positive electrode 120, the separator 130, and the negative electrode 140 inside a hermetically sealing container.

The electrolyte solution of the present embodiment contains a lithium salt and a cyclic fluorine compound having a cyclic hydrocarbon skeleton in which at least one hydrogen atom is substituted with a fluorine atom (hereinafter, also simply referred to as “cyclic fluorine compound”).

In general, in an anode-free lithium secondary battery having the electrolyte solution, the SEI layer is formed on the surface of the negative electrode or the like by decomposing the solvent or the like in the electrolyte solution. Due to the SEI layer in the lithium secondary battery, further decomposition of components in the electrolyte solution, irreversible reduction of lithium ions caused by the decomposition, generation of gas, and the like are suppressed. In addition, because the SEI layer has ionic conductivity, reactivity of lithium deposition reaction on the surface of the negative electrode, on which the SEI layer is formed, is uniform in a plane direction of the surface of the negative electrode. Therefore, promoting the formation of the SEI layer is very important for improving the performance of the anode-free lithium secondary battery. The present inventors have found that, in the lithium secondary battery containing the aforesaid cyclic fluorine compound as a solvent, good-quality SEI layer is easily formed on the surface of the negative electrode, and the growth of a lithium metal into dendrite form on the negative electrode is suppressed, and as a result, the cycle characteristic is improved. The factor is not necessarily clear, but the following factors can be presumed.

It is presumed that not only the lithium ions but also the aforesaid cyclic fluorine compound as a solvent are reduced on the negative electrode during charging of the lithium secondary battery 100, particularly during initial charging. It is presumed that, due to the partial substitution of fluorine in the structure of the cyclic fluorine compound, a reaction such as the elimination of a portion of the cyclic hydrocarbon skeleton, in which a particularly weak bond has been made, is likely to occur. As a result, during charging of the lithium secondary battery 100, a part or all of the cyclic fluorine compound are absorbed on the surface of the negative electrode, and since the SEI layer is formed starting from the absorbed portion, it is presumed that the SEI layer is likely to be formed in the lithium secondary battery 100. The factor is however not limited to the aforesaid one.

Further, it has been found that, since the cyclic fluorine compound has a cyclic hydrocarbon skeleton in which at least one hydrogen atom is substituted with a fluorine atom, the compatibility with other solvents in the electrolyte solution is high. This is presumed to be because the cyclic fluorine compound exhibits higher polarity than a chain-like fluorine compound due to the restricted conformation of the molecular structure. The factor is however not limited to the aforesaid one. Therefore, it is presumed that the aforesaid cyclic fluorine compound is evenly distributed in the electrolyte solution and forms a more uniform SEI layer.

As described above, since the cyclic fluorine compound tends to have higher polarity than the chain-like fluorine compound, it tends to have a strong intermolecular interaction and have a high boiling point. Since a vapor pressure of the electrolyte solution containing such a cyclic fluorine compound tends to be low, the lithium secondary battery of the present embodiment tends to have a low volume expansion ratio and excellent safety even when the battery is repeatedly charged/discharged.

The “cyclic hydrocarbon skeleton” as used herein means a structure in which a hydrocarbon chain is cyclic, which is formed by bonding a plurality of carbon atoms to a ring, and can be replaced by a cycle-type hydrocarbon skeleton. In addition, in the cyclic hydrocarbon skeleton, a hydrogen atom directly bonded to a cyclically bonded carbon atom may be substituted with any substituent. That is, the cyclic hydrocarbon skeleton includes a cyclic structure consisting of a plurality of carbon atoms, hydrogen atoms bonded to the cyclic structure, and/or a substituent. In the cyclic hydrocarbon skeleton, all hydrogen atoms may be substituted with substituents.

The “fluorine compound” as used herein means a compound having at least one fluorine atom.

The electrolyte solution of the present embodiment typically contains the cyclic fluorine compound as a solvent. That is, in the usage environment of lithium secondary batteries, it is preferable that the electrolyte can be dissolved in the cyclic fluorine compound to form an electrolyte solution in a solution phase, or the compound alone or a mixture with other compounds is liquid.

It is preferable that the cyclic fluorine compound contained in the electrolyte solution of the present embodiment has polarity. When the cyclic fluorine compound has polarity, the compatibility between solvents in the electrolyte solution is improved, and as a result of uniform formation of the SEI layer, the growth of a lithium metal into dendrite form on the surface of the negative electrode can be suppressed, and the lithium secondary battery tends to have excellent cycle characteristic.

The compound “having polarity” as used herein means that a center of gravity of a positive charge and a center of gravity of a negative charge do not match in the molecular structure of the compound. That is, when a dipole moment is not 0 in the entire molecule, it can be said to have polarity.

The cyclic fluorine compound contained in the electrolyte solution of the present embodiment has a cyclic hydrocarbon skeleton in which at least one hydrogen atom is substituted with a fluorine atom. In the cyclic fluorine compound, a ratio (F/(F+H)) of the number (F) of fluorine atoms to the total number (F+H) of fluorine atoms and hydrogen atoms is not particularly limited, but for example, it is 0.10 or more and 1.0 or less. From the standpoint of improving the cycle characteristic of the battery and/or improving the stability, the aforesaid ratio (F/(F+H)) is preferably 0.20 or more, 0.25 or more, 0.30 or more, 0.35 or more, 0.40 or more, 0.45 or more, or 0.50 or more. In addition, from a similar standpoint, the aforesaid ratio (F/(F+H)) is preferably less than 1.0, 0.95 or less, 0.90 or less, 0.85 or less, or 0.80 or less. The aforesaid ratio (F/(F+H)) is particularly preferably, for example, 0.7 or more and 1.0 or less.

The number of fluorine atoms in the cyclic fluorine compound is not particularly limited insofar as it is 1 or more, and for example, it is 1 or more and 45 or fewer. From the standpoint of improving the cycle characteristic of the battery and/or improving the stability, the number of fluorine atoms in the cyclic fluorine compound is preferably 3 or more, 5 or more, 6 or more, or 7 or more. In addition, from a similar standpoint, it is preferably 40 or fewer, 35 or fewer, 30 or fewer, 25 or fewer, 20 or fewer, 15 or fewer, or 10 or fewer.

In the cyclic fluorine compound of the present embodiment, the number of carbon atoms constituting the cyclic hydrocarbon skeleton (that is, constituting a ring) is not particularly limited, and for example, it is 3 or more and 20 or fewer. From the standpoint of further improving the cycle characteristic and the safety, the number of carbon atoms constituting the cyclic hydrocarbon skeleton is preferably 4 or more, 5 or more, or 6 or more. In addition, from a similar standpoint, the number of carbon atoms is preferably 18 or fewer, 15 or fewer, 12 or fewer, 10 or fewer, or 8 or fewer. The aforesaid number of carbon atoms is particularly preferably 5 or 6. When the cyclic hydrocarbon skeleton has a skeleton in which two or more cyclic structures such as a bicyclo ring are fused, the number of carbon atoms constituting each ring is preferably 3 or more and 10 or fewer.

The number of carbon atoms constituting the cyclic fluorine compound of the present embodiment is not particularly limited, and for example, it is 4 or more and 30 or fewer. In addition, the number of carbon atoms constituting the cyclic fluorine compound may be 5 or more and 25 or fewer, 6 or more and 20 or fewer, 7 or more and 15 or fewer, or 8 or more and 12 or fewer.

In the cyclic fluorine compound of the present embodiment, the cyclic hydrocarbon skeleton may be a saturated cyclic hydrocarbon skeleton or an unsaturated cyclic hydrocarbon skeleton. From the standpoint of improving the cycle characteristic of the battery, the cyclic fluorine compound preferably has a saturated cyclic hydrocarbon skeleton. The “saturated cyclic hydrocarbon skeleton” means that all bonds between carbon atoms constituting the cyclic hydrocarbon skeleton are single bonds. In addition, the “unsaturated cyclic hydrocarbon skeleton” means that at least one of the bonds between carbon atoms constituting the cyclic hydrocarbon skeleton is a bond that is not a single bond (a double bond or a triple bond). From a similar standpoint, the cyclic fluorine compound of the present embodiment preferably does not have a carbon-carbon double bond, and more preferably does not have a double bond.

In the cyclic fluorine compound of the present embodiment, the cyclic hydrocarbon skeleton may have a substituent other than the fluorine atom. Examples of such a substituent include an alkyl group, an alkenyl group, an alkynyl group, a cycloalkyl group, a cycloalkenyl group, a cycloalkynyl group, and an aryl group, each may further have a substituent; a nitrile group; a halogen group; a silyl group; a hydroxy group; an alkoxy group which may further have a substituent; and an aryloxy group which may further have a substituent. Examples of the aryl group include a phenyl group, a naphthyl group, a furyl group, a thienyl group, and a pyridyl group. When the substituent has a hydrocarbon chain, such a hydrocarbon chain may be linear or branched.

Examples of the substituent which may be further included in the aforesaid alkyl group, alkenyl group, alkynyl group, cycloalkyl group, cycloalkenyl group, cycloalkynyl group, aryl group, alkoxy group, and aryloxy group include a nitrile group, a halogen group, a silyl group, and a hydroxy group.

The number of substituents other than the fluorine atom, bonded to the cyclic hydrocarbon skeleton of the cyclic fluorine compound, is not particularly limited, and for example, it may be 1 or more and 10 or fewer. Within the aforesaid range, the number of substituents other than the fluorine atom may be 8 or fewer, 5 or fewer, 4 or fewer, 3 or fewer, or 2 or fewer.

When the substituent bonded to the cyclic hydrocarbon skeleton has a carbon atom, the number of carbon atoms in the substituent is preferably 1 or more and 10 or fewer, and more preferably 1 or more and 5 or fewer, or 1 or more and 3 or fewer. It is preferable that the substituent bonded to the cyclic hydrocarbon skeleton is selected from an alkyl group, alkenyl group, and alkynyl group having 1 or more and 5 or fewer (preferably 1 or more and 3 or fewer) carbon atoms, which may have a substituent. It is more preferable that the substituent bonded to the cyclic hydrocarbon skeleton is selected from an alkyl group, alkenyl group, and alkynyl group having 1 or more and 5 or fewer (preferably 1 or more and 3 or fewer) carbon atoms, which may have a halogen group (preferably a fluorine atom). It is still more preferable that the substituent bonded to the cyclic hydrocarbon skeleton is an alkyl group having 1 or more and 3 or fewer carbon atoms, which may be substituted with a fluorine atom.

The substituent bonded to the cyclic hydrocarbon skeleton is preferably substituted with a fluorine atom. The substituent substituted with a fluorine atom is not particularly limited, and examples thereof include a trifluoromethyl group, a tetrafluoroethyl group, a perfluoroethyl group, a tetrafluoropropyl group, a perfluorobutyl group, a perfluorohexyl group, a perfluorooctyl group, a perfluorodecyl group, a fluoromethoxy group, a fluoroethoxy group, a fluoropropoxy group, and a fluorobutoxy group. Among such substituents of fluorine compound, from the standpoint of further improving the cycle characteristic of the lithium secondary battery, a trifluoromethyl group, a tetrafluoroethyl group, a tetrafluoropropyl group, a fluoroethoxy group, or a fluoropropoxy group is preferable, a trifluoromethyl group, a 1,1,2,2-tetrafluoroethoxy group, a 1,1,2,2-tetrafluoropropoxy group, or a 2,2,3,3-tetrafluoropropoxy group is more preferable, and a trifluoromethyl group is still more preferable.

Examples of a suitable mode of the cyclic fluorine compound of the present embodiment include a cyclic fluorine compound in which the ratio (F/(F+H)) of the number (F) of fluorine atoms to the total number (F+H) of fluorine atoms and hydrogen atoms is 0.7 or more and 1.0 or less, and the number of carbon atoms constituting the cyclic hydrocarbon skeleton is 5 or 6. In such a mode, the cycle characteristic and/or safety of the battery tends to be improved further.

The cyclic fluorine compound in the present embodiment is not particularly limited, and examples thereof include 1,1,2,2,3,3,4-heptafluorocyclopentane, hexadecafluoro(1,3-dimethylcyclohexane), tetradecafluoromethylcyclohexane, fluorocyclohexane, fluorocyclopentane, octadecafluorodecahydronaphthalene, octafluorocyclobutane, octafluoronaphthalene, and perfluoroanthracene. From the standpoint of effectively and reliably exhibiting the aforesaid effects of the cyclic fluorine compound in the present embodiment, as the cyclic fluorine compound, 1,1,2,2,3,3,4-heptafluorocyclopentane, hexadecafluoro(1,3-dimethylcyclohexane), tetradecafluoromethylcyclohexane, fluorocyclohexane, fluorocyclopentane, or octadecafluorodecahydronaphthalene is preferable, 1,1,2,2,3,3,4-heptafluorocyclopentane or hexadecafluoro(1,3-dimethylcyclohexane) is more preferable, and 1,1,2,2,3,3,4-heptafluorocyclopentane is still more preferable.

In the present embodiment, the electrolyte solution may contain at least one cyclic fluorine compound, or may contain two or more kinds thereof in combination.

The content of the cyclic fluorine compound in the electrolyte solution of the present embodiment is not particularly limited, and for example, it is 1.0 vol. % or more and 95 vol. % or less based on the total amount of solvent components in the electrolyte solution. From the standpoint of effectively and reliably exhibiting the aforesaid effects of the cyclic fluorine compound in the lithium secondary battery, based on the total amount of solvent components in the electrolyte solution, the content of the cyclic fluorine compound is preferably 5.0 vol. % or more, 10 vol. % or more, or 15 vol. % or more, and may be 20 vol. % or more, 25 vol. % or more, 30 vol. % or more, or 50 vol. % or more. In addition, from a similar standpoint, based on the total amount of solvent components in the electrolyte solution, the content of the cyclic fluorine compound is preferably 90 vol. % or less or 85 vol. % or less, and may be 80 vol. % or less, 70 vol. % or less, 60 vol. % or less, or 55 vol. % or less.

The electrolyte solution of the present embodiment may contain a fluorine compound other than the aforesaid cyclic fluorine compound as a solvent. Such a fluorine compound is, for example, a chain-like fluorine compound. From the standpoint of further improving the cycle characteristic of the lithium secondary battery, the electrolyte solution of the present embodiment preferably contains a chain-like fluorine compound. From the standpoint of stability of the lithium secondary battery, the electrolyte solution of the present embodiment preferably contains only the aforesaid cyclic fluorine compound as a solvent having a fluorine atom. The electrolyte solution of the present embodiment may contain only the aforesaid cyclic fluorine compound and a first chain-like fluorine compound, which will be described later, as a solvent having a fluorine atom.

Among such chain-like fluorine compounds, the electrolyte solution of the present embodiment preferably further contains a chain-like fluorine compound having at least one of a monovalent group represented by Formula (A) or a monovalent group represented by Formula (B) (hereinafter, also referred to as “first chain-like fluorine compound”). Since the electrolyte solution contains the aforesaid first chain-like fluorine compound, the SEI layer is likely to be formed during charging, particularly during initial charging of the lithium secondary battery, and the lithium secondary battery tends to have excellent cycle characteristic and/or rate characteristic.

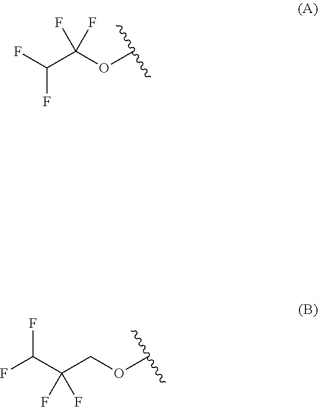

In the formulae, a wavy line represents a bonding site in the monovalent group.

The first chain-like fluorine compound in the present embodiment includes a compound including both the structures represented by Formula (A) and Formula (B), a compound that includes the structure represented by Formula (A) and does not include the structure represented by Formula (B), and a compound that does not include the structure represented by Formula (A) and includes the structure represented by Formula (B).

In addition, the electrolyte solution of the present embodiment may contain a chain-like fluorine compound other than the aforesaid first chain-like fluorine compound. That is, the electrolyte solution of the present embodiment may contain a chain-like fluorine compound that does not include both the structures represented by Formula (A) and Formula (B) (hereinafter, also referred to as “second chain-like fluorine compound”).

The number of carbon atoms in the first chain-like fluorine compound is not particularly limited, and for example, it is 3 or more and 15 or fewer. From the standpoint of further improving the solubility of the electrolyte in the electrolyte solution, the number of carbon atoms in the first chain-like fluorine compound is preferably 4 or more, 5 or more, or 6 or more. In addition, from a similar standpoint, the number of carbon atoms in the first chain-like fluorine compound is preferably 14 or fewer, 12 or fewer, 10 or fewer, or 8 or fewer.

The number of carbon atoms in the second chain-like fluorine compound is not particularly limited, and for example, it is 3 or more and 20 or fewer. From the standpoint of further improving the solubility of the electrolyte in the electrolyte solution, the number of carbon atoms in the second chain-like fluorine compound is preferably 4 or more, 5 or more, 6 or more, 7 or more, 8 or more, or 10 or more. In addition, from a similar standpoint, the number of carbon atoms in the second chain-like fluorine compound is preferably 18 or fewer, 15 or fewer, or 12 or fewer.

In the present embodiment, the first chain-like fluorine compound is not particularly limited insofar as it is a compound having a monovalent group represented by Formula (A) or Formula (B) above, and examples thereof include a compound having an ether bond, a compound having an ester bond, and a compound having a carbonate bond. From the standpoints of further improving the solubility of the electrolyte in the electrolyte solution and further improving the cycle characteristic of the battery, the first chain-like fluorine compound is preferably an ether compound having an ether bond.

The first chain-like fluorine compound that is an ether compound is not particularly limited. Examples of the compound including both the structures represented by Formula (A) and Formula (B) include 1,1,2,2-tetrafluoroethyl-2,2,3,3-tetrafluoropropyl ether and 1,1,2,2-tetrafluoroethoxy-2,2,3,3-tetrafluoropropoxymethane.

In addition, examples of the compound that includes the structure represented by Formula (A) and does not include the structure represented by Formula (B) include 1,1,2,2-tetrafluoroethyl-2,2,2-trifluoroethyl ether, methyl-1,1,2,2-tetrafluoroethyl ether, ethyl-1,1,2,2-tetrafluoroethyl ether, and propyl-1,1,2,2-tetrafluoroethyl ether.

Further, examples of the compound that does not include the structure represented by Formula (A) and includes the structure represented by Formula (B) include difluoromethyl-2,2,3,3-tetrafluoropropyl ether, trifluoromethyl-2,2,3,3-tetrafluoropropyl ether, and difluoromethyl-2,2,3,3-tetrafluoropropyl ether.

From the standpoint of improving the cycle characteristic and/or rate characteristic of the lithium secondary battery, the first chain-like fluorine compound is preferably selected from 1,1,2,2-tetrafluoroethyl-2,2,3,3-tetrafluoropropyl ether and 1,1,2,2-tetrafluoroethyl-2,2,2-trifluoroethyl ether.

The second chain-like fluorine compound is not particularly limited, and examples thereof include methyl nonafluorobutyl ether, ethyl nonafluorobutyl ether, 1,1,1,2,2,3,4,5,5,5-decafluoro-3-methoxy-4-trifluoromethylpentane, methyl-2,2,3,3,3-pentafluoropropyl ether, and 1,1,2,3,3,3-hexafluoropropylmethyl ether.

When the electrolyte solution contains a fluorine compound other than the cyclic fluorine compound, the content of the cyclic fluorine compound is not particularly limited, and based on the total amount of the fluorine compound, it may be 10 vol. % or more, 15 vol. % or more, 20 vol. % or more, or 25 vol. % or more, and may be 90 vol. % or less, 80 vol. % or less, 70 vol. % or less, or 50 vol. % or less.

When the electrolyte solution contains the first chain-like fluorine compound, the content of the first chain-like fluorine compound is not particularly limited, and based on the total amount of the fluorine compound, it may be 50 vol. % or more, 60 vol. % or more, or 70 vol. % or more, and may be 95 vol. % or less, 90 vol. % or less, or 85 vol. % or less.

When the electrolyte solution contains the second chain-like fluorine compound, the content of the second chain-like fluorine compound is not particularly limited, and based on the total amount of the fluorine compound, it may be 5 vol. % or more or 10 vol. % or more, and may be 50 vol. % or less, 40 vol. % or less, 30 vol. % or less, 20 vol. % or less, or 15 vol. % or less.

When the electrolyte solution contains two or more kinds of the cyclic fluorine compounds, the total amount thereof is defined as the content of the cyclic fluorine compound. The same applies to a case where the electrolyte solution contains two or more kinds of the first chain-like fluorine compounds or the second chain-like fluorine compounds.

The content of the first chain-like fluorine compound in the electrolyte solution is not particularly limited, and for example, it is 0 vol. % or more and 90 vol. % or less based on the total amount of solvent components in the electrolyte solution. The content of the first chain-like fluorine compound is preferably 5 vol. % or more, 10 vol. % or more, 15 vol. % or more, 20 vol. % or more, 30 vol. % or more, or 40 vol. % or more. In addition, the content of the first chain-like fluorine compound is preferably 85 vol. % or less, 80 vol. % or less, 75 vol. % or less, 70 vol. % or less, 65 vol. % or less, 60 vol. % or less, or 50 vol. % or less.

In the present embodiment, the electrolyte solution preferably contains an ether compound not having a fluorine atom (hereinafter, referred to as “ether co-solvent”) as a solvent. In such a mode, since the solubility of the electrolyte in the electrolyte solution is improved further, the ionic conductivity of the electrolyte solution is improved, and as a result, the lithium secondary battery 100 has excellent cycle characteristic. The ether co-solvent is not particularly limited insofar as it is a compound that does not have a fluorine atom and has an ether bond. In the usage environment of lithium secondary batteries, it is preferable that the electrolyte can be dissolved in the ether co-solvent to form an electrolytesolution in a solution phase, or the compound alone or a mixture with other compounds is liquid.

The number of carbon atoms in the ether co-solvent is not particularly limited, and for example, it is 2 or more and 20 or fewer. From the standpoint of further improving the cycle characteristic of the battery, the number of carbon atoms in the ether co-solvent is preferably 3 or more or 4 or more, and may be 5 or more or 6 or more. In addition, from a similar standpoint, the number of carbon atoms in the ether co-solvent is preferably 15 or fewer, 12 or fewer, 10 or fewer, 9 or fewer, or 7 or fewer.

The number of ether bonds in the ether co-solvent is not particularly limited, and for example, it is 1 or more and 10 or fewer. From the standpoint of further improving the cycle characteristic of the battery, the ether co-solvent preferably has 2 or more ether bonds, and may have 3, 4, 5, 6, 7, or 8 ether bonds. The number of ether bonds is preferably 2 or more and 5 or fewer.

The ether co-solvent is not particularly limited insofar as it is an ether compound not having a fluorine atom, and examples thereof include triethylene glycol dimethyl ether, diethylene glycol dimethyl ether, 1,2-dimethoxyethane, 1,3-dimethoxypropane, 1,4-dimethoxybutane, 1,1-dimethoxyethane, 1,2-dimethoxypropane, 2,2-dimethoxypropane, 1,3-dimethoxybutane, 1,2-dimethoxybutane, 2,2-dimethoxybutane, 2,3-dimethoxybutane, 1,2-diethoxypropane, 1,2-diethoxybutane, 2,3-diethoxybutane, and diethoxyethane. From the standpoint of further improving the cycle characteristic of the battery, the ether co-solvent is preferably 1,2-dimethoxyethane, 1,2-dimethoxypropane, or 2,2-dimethoxypropane.

The content of the ether co-solvent in the electrolyte solution of the present embodiment is not particularly limited, and for example, it is 0 vol. % or more and 80 vol. % or less based on the total amount of solvent components in the electrolyte solution. From the standpoint of effectively and reliably exhibiting the aforesaid effects of the cyclic fluorine compound in the lithium secondary battery, based on the total amount of solvent components in the electrolyte solution, the content of the ether co-solvent is preferably 5.0 vol. % or more, 10 vol. % or more, 15 vol. % or more, or 20 vol. % or more. In addition, from a similar standpoint, based on the total amount of solvent components in the electrolyte solution, the content of the ether co-solvent is preferably 75 vol. % or less, 70 vol. % or less, 65 vol. % or less, 60 vol. % or less, or 55 vol. % or less.

The electrolyte solution may further contain a compound not having a fluorine atom, other than the aforesaid ether co-solvent (hereinafter, also referred to as “non-ether co-solvent”) as a solvent. The non-ether co-solvent is not particularly limited, and examples thereof include acetonitrile, dimethyl carbonate, diethyl carbonate, ethyl methyl carbonate, ethylene carbonate, propylene carbonate, chloroethylene carbonate, methyl acetate, ethyl acetate, propyl acetate, methyl propionate, ethyl propionate, trimethyl phosphate, and triethyl phosphate. The non-ether co-solvent may have at least one group selected from the group consisting of a carbonate group, a carbonyl group, a ketone group, and an ester group.

It is sufficient that the electrolyte solution contains at least one cyclic fluorine compound. From the standpoints of further improving the solubility of the electrolyte in the electrolyte solution and further improving the cycle characteristic of the battery, the electrolyte solution preferably contains two or more kinds of the fluorine compounds. From a similar standpoint, the electrolyte solution preferably contains at least one cyclic fluorine compound and at least one first chain-like fluorine compound.

The aforesaid cyclic fluorine compound, the aforesaid first chain-like fluorine compound, the aforesaid second chain-like fluorine compound, the aforesaid ether co-solvent, and the aforesaid non-ether co-solvent can be used in any optional combination as the solvent of the electrolyte solution. In addition, for each solvent, one or more of solvents may be used either singly or in combination. In the electrolyte solution, as the compound not having a fluorine atom, the ether co-solvent may be used singly, or the ether co-solvent may be used in combination with the non-ether co-solvent.

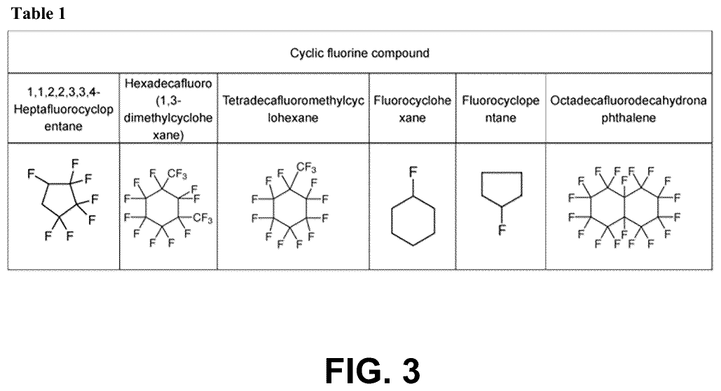

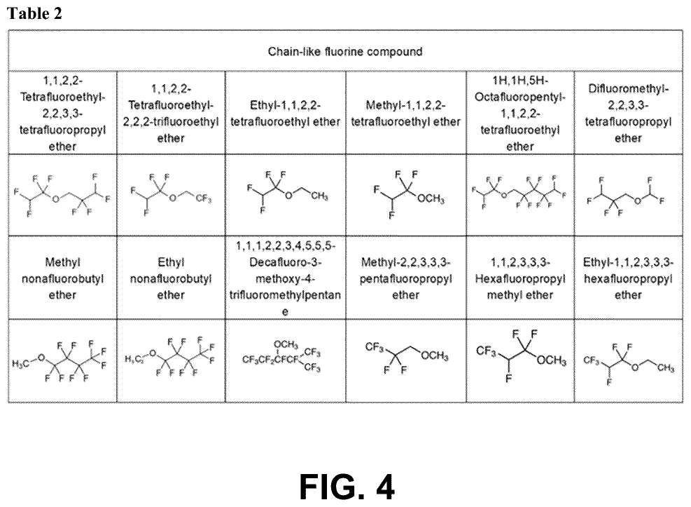

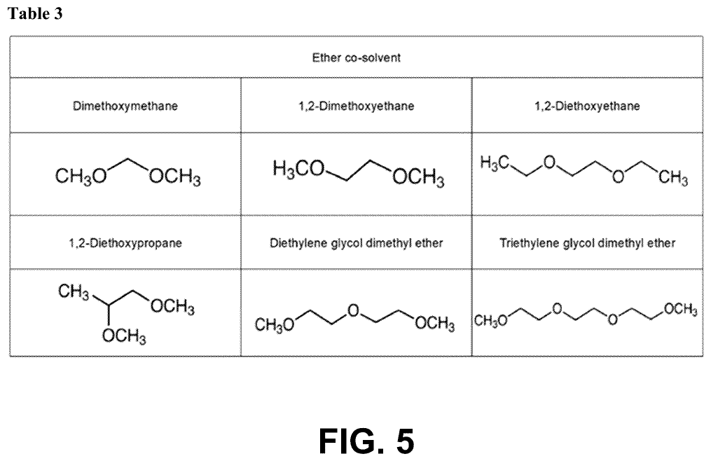

Structural formulae of the compounds that can be contained in the present embodiment as the solvent are exemplified in the tables below. Table 1 of FIG. 3 shows examples of the aforesaid cyclic fluorine compound. In addition, Table 2 of FIG. 4 shows examples of the aforesaid first chain-like fluorine compound and the aforesaid second chain-like fluorine compound. Further, Table 3 of FIG. 5 shows examples of the ether co-solvent. However, the types of compounds that can be used as the solvent are not limited thereto.

The lithium salt contained in the electrolyte solution is not particularly limited, and examples thereof include inorganic salts and organic salts of lithium. Specific examples thereof include LiI, LiCl, LiBr, LiF, LiBF4, LiPF6, LiAsF6, LiSO3CF3, LiN(SO2F)2, LiN(SO2CF3)2, LiN(SO2CF3CF3)2, LiBF2(C2O4), LiB(O2C2H4)2, LiB(O2C2H4)F2, LiB(OCOCF3)4, LiNO3, and Li2SO4. The lithium salt is preferably LiN(SO2F)2 from the standpoint of providing a lithium secondary battery 100 having more excellent energy density and cycle characteristic. One or more of the aforesaid lithium salts may be used either singly or in combination.

The electrolyte solution may further contain a salt other than the lithium salt as the electrolyte. Examples of such a salt include salts of Na, K, Ca, or Mg.

The concentration of the lithium salt in the electrolyte solution is not particularly limited, but is preferably 0.5 M or more, more preferably 0.7 M or more, still more preferably 0.9 M or more, and still more preferably 1.0 M or more. When the concentration of the lithium salt falls within the aforesaid range, the SEI layer is more easily formed and the internal resistance tends to be further lowered. In particular, in the lithium secondary battery 100 containing the fluorine compound as the solvent, the concentration of the lithium salt in the electrolyte solution can be increased, so that the cycle characteristic and rate capability can be improved further. The upper limit of the concentration of the lithium salt is not particularly limited, and the concentration of the lithium salt may be 10.0 M or less, 5.0 M or less, or 2.0 M or less.

The lithium secondary battery of the present embodiment may contain the electrolyte solution or the components of the electrolyte solution in a state other than the liquid. For example, by adding an electrolyte solution when preparing the separator described later, a battery can be obtained in which the electrolyte solution is contained in a solid or semi-solid (gel) member. In addition, the electrolyte solution can be replaced by the electrolyte.

The fact that the electrolyte solution contains the cyclic fluorine compound, the ether co-solvent, and the like can be confirmed by various conventionally known methods. Examples of such a method include an NMR measurement method, a mass analysis method such as HPLC-MS, and an IR measurement method.

The molecular structure of the solvent contained in the electrolyte solution can be estimated by measurement or analysis with a known method. Examples of such a method include a method using NMR, mass analysis, elemental analysis, infrared spectroscopy, and the like. In addition, the molecular structure of the solvent can be estimated by theoretical calculation using a molecular dynamics method, a molecular orbital method, and the like.

Solid Electrolyte Interfacial Layer

It is presumed that, in the lithium secondary battery 100, the solid electrolyte interfacial layer (SEI layer) is formed on the surface of the negative electrode 140 by charging, particularly initial charging, but the lithium secondary battery 100 may not have the SEI layer. It is presumed that the SEI layer to be formed contains an organic compound derived from the aforesaid cyclic fluorine compound and the lithium salt, but for example, other lithium-containing inorganic compounds, lithium-containing organic compounds, and/or the like may be contained.

The lithium-containing organic compound and the lithium-containing inorganic compound are not particularly limited insofar as they are contained in a conventionally known SEI layer. Examples of the lithium-containing organic compound include, but are not limited to, organic compounds such as lithium alkyl carbonate, lithium alkoxide, and lithium alkyl ester, and examples of the lithium-containing inorganic compound include, but are not limited to, LiF, Li2CO3, Li2O, LiOH, a lithium borate compound, a lithium phosphate compound, a lithium sulfate compound, a lithium nitrate compound, a lithium nitrite compound, and a lithium sulfite compound.

Since the lithium secondary battery 100 contains the cyclic fluorine compound as a solvent and can further contain the chain-like fluorine compound, it is presumed that the formation of the SEI layer is promoted. Since the SEI layer has ionic conductivity, reactivity of lithium deposition reaction on the surface of the negative electrode, on which the SEI layer is formed, is uniform in a plane direction of the surface of the negative electrode. In the lithium secondary battery 100, the growth of a lithium metal into dendrite form on the negative electrode is suppressed, it is presumed that the lithium secondary battery 100 has excellent cycle characteristic.

The typical average thickness of the SEI layer is 1 nm or more and 10 μm or less. When the SEI layer is formed in the lithium secondary battery 100, the lithium metal deposited by charging the battery may precipitate at the interface between the negative electrode 140 and the SEI layer, and may precipitate at the interface between the SEI layer and the separator.

Positive Electrode

The positive electrode 120 is not particularly limited insofar as it is a positive electrode commonly used in a lithium secondary battery, and a known material can be selected as needed, depending on the use of the lithium secondary battery. From the standpoint of increasing the stability and output voltage of the lithium secondary battery 100, the positive electrode 120 preferably has a positive-electrode active material.

The “positive-electrode active material” as used herein means a material used for retaining a lithium element (typically, a lithium ion) in the positive electrode of the battery, and may be replaced by a host material for the lithium element (typically, a lithium ion). Such a positive-electrode active material is not particularly limited, and examples thereof include metal oxides and metal phosphates. The metal oxides are not particularly limited, and examples thereof include cobalt oxide-based compounds, manganese oxide-based compounds, and nickel oxide-based compounds. The metal phosphates are not particularly limited, and examples thereof include iron phosphate-based compounds and cobalt phosphate-based compounds. Examples of typical positive-electrode active materials include LiCoO2, LiNixCoyMnzO2 (x+y+z=1), LiNixCoyAlzO (x+y+z=1), LiNixMnyO2 (x+y=1), LiNiO2, LiMn2O4, LiFePO4, LiCoPO4, FeF3, LiFeOF, LiNiOF, and TiS2.

One or more of the positive-electrode active materials may be used either singly or in combination. The positive electrode 120 may contain components other than the aforesaid positive-electrode active material. Such a component is not particularly limited, and examples thereof include conductive additives, binders, and electrolytes.

The conductive additive to be contained in the positive electrode 120 is not particularly limited, and examples thereof include carbon black, single wall carbon nanotube (SW-CNT), multi-wall carbon nanotube (MW-CNT), carbon nanofiber, and acetylene black.

The binder is not particularly limited, and examples thereof include polyvinylidene fluoride, polytetrafluoroethylene, styrene butadiene rubber, acrylic resins, and polyimide resins.

In addition, examples of the electrolyte in the positive electrode 120 include a polymer electrolyte, a gel electrolyte, and an inorganic solid electrolyte, and a typical electrolyte is a polymer electrolyte or a gel electrolyte. As the polymer electrolyte and the gel electrolyte, electrolytes described later may be used.

One or more of the conductive additives, binders, and electrolytes as described above may be used either singly or in combination.

The content of the positive-electrode active material in the positive electrode 120 may be, for example, 50 mass % or more and 100 mass % or less based on the total amount of the positive electrode 120. The content of the conductive additive may be, for example, 0.5 mass % or more and 30 mass % or less based on the total amount of the positive electrode 120. The content of the binder may be, for example, 0.5 mass % or more and 30 mass % or less based on the total amount of the positive electrode 120. The total amount of the electrolytes may be, for example, 0.5 mass % or more and 30 mass % or less based on the total amount of the positive electrode 120.

The average thickness of the positive electrode 120 is, for example, 10 μm or more and 300 μm or less, and is preferably 30 μm or more and 200 μm or less, or 50 μm or more and 150 μm or less. However, the average thickness of the positive electrode can be appropriately adjusted according to a desired capacity of the battery.

Positive Electrode Current Collector

The positive electrode 120 has, on one side thereof, a positive electrode current collector 110. The positive electrode current collector 110 is not particularly limited insofar as it is a conductor not reactive with a lithium ion in the battery. Examples of such a positive electrode current collector include aluminum.

The average thickness of the positive electrode current collector 110 of the present embodiment is preferably 4 μm or more and 20 μm or less, more preferably 5 μm or more and 18 μm or less, and still more preferably 6 μm or more and 15 μm or less. In such a mode, the occupation volume of the positive electrode current collector 110 in the lithium secondary battery 100 decreases and the resulting lithium secondary battery 100 therefore has a more improved energy density.

Separator

The separator 130 of the present embodiment is a member for separating the positive electrode 120 from the negative electrode 140 to prevent a short circuit of the battery and in addition, for securing the ionic conductivity of a lithium ion which serves as a charge carrier between the positive electrode 120 and the negative electrode 140. That is, the separator 130 has a function of separating the positive electrode 120 and the negative electrode 140, and a function of securing ionic conductivity of lithium ions. The separator 130 also has a role of retaining electrolyte solution. As such a separator, one member having the aforesaid two functions may be used singly, or two or more members each having the aforesaid one function may be used in combination. The separator is not particularly limited insofar as it has the aforesaid functions, and examples thereof include a porous member having insulating properties, a polymer electrolyte, a gel electrolyte, and an inorganic solid electrolyte. Typically, it is at least one selected from the group consisting of a porous member having insulating properties, a polymer electrolyte, and a gel electrolyte.

When the separator 130 includes a porous member having insulating properties, the member exhibits ionic conductivity by filling pores of the member with a material having ionic conductivity. Examples of the material to be filled include the electrolyte solution, polymer electrolyte, and gel electrolyte described above.

As the separator 130, one or more of the porous member having insulating properties, the polymer electrolyte, or the gel electrolyte may be used either singly or in combination.

A material constituting the aforesaid porous member having insulating properties is not particularly limited, and examples thereof include an insulating polymer material, and specific examples thereof include polyethylene (PE) and polypropylene (PP). That is, the separator 130 may be a porous polyethylene (PE) film, a porous polypropylene (PP) film, or a stacked structure thereof.

The aforesaid polymer electrolyte is not particularly limited, and examples thereof include a solid polymer electrolyte mainly containing a polymer and an electrolyte and a semi-solid polymer electrolyte mainly containing a polymer, an electrolyte, and a plasticizer.

The aforesaid gel electrolyte is not particularly limited, and examples thereof include gel electrolytes mainly containing a polymer and a liquid electrolyte (that is, a solvent and an electrolyte).

The polymer that can be contained in the polymer electrolyte and the gel electrolyte is not particularly limited, and examples thereof include a polymer including a functional group having an oxygen atom, such as ether and ester, and a polymer including a polar group such as a halogen group and a cyano group. Specific examples thereof include resins having an ethylene oxide unit in the main chain and/or side chain, such as polyethylene oxide (PEO), resins having a propylene oxide unit in the main chain and/or side chain, such as polypropylene oxide (PPO), acrylic resins, vinyl resins, ester resins, nylon resins, polyvinylidene fluoride (PVDF), polyacrylonitrile (PAN), polysiloxane, polyphosphazene, poly(methyl methacrylate), polyamide, polyimide, aramid, polylactic acid, polyurethane, polyacetal, polysulfone, polyethylene carbonate, polypropylene carbonate, and polytetrafluoroethylene. One or more of the aforesaid resins may be used either singly or in combination.

Examples of the electrolyte contained in the polymer electrolyte or the gel electrolyte include salts of Li, Na, K, Ca, or Mg. Typically, in the present embodiment, the polymer electrolyte and the gel electrolyte contain a lithium salt.

The lithium salt is not particularly limited, and examples thereof include LiI, LiCl, LiBr, LiF, LiBF4, LiPF6, LiAsF6, LiSO3CF3, LiN(SO2F)2, LiN(SO2CF3)2, LiN(SO2CF3CF3)2, LiB(02C2H4)2, LiB(C2O4)2, LiB(02C2H4)F2, LiB(OCOCF3)4, LiNO3, and Li2SO4. At least one selected from the group consisting of LiN(SO2F)2, LiN(SO2CF3)2, and LiN(SO2CF3CF3)2 is preferable. One or more of the aforesaid salts or lithium salts may be used either singly or in combination.

The mixing ratio of the polymer and the lithium salt in the polymer electrolyte and the gel electrolyte may be determined by a ratio of the lithium atom which the lithium salt has to the polar group which the polymer has. For example, when the polymer has an oxygen atom, the mixing ratio of the polymer and the lithium salt in the polymer electrolyte and the gel electrolyte may be determined based on a ratio ([Li]/[O]) of the number of lithium atoms in the lithium salt to the number of oxygen atoms in the polymer. In the polymer electrolyte and the gel electrolyte, the mixing ratio of the polymer and the lithium salt may be adjusted so that the aforesaid ratio ([Li]/[O]) be, for example, 0.02 or more and 0.20 or less, 0.03 or more and 0.15 or less, or 0.04 or more and 0.12 or less.

The solvent contained in the gel electrolyte is not particularly limited, and for example, one or more of the solvents that can be contained in the aforesaid electrolyte solution may be used singly or in combination. Examples of a preferred solvent are also the same as those in the aforesaid electrolyte solution.

The plasticizer contained in the semi-solid polymer electrolyte is not particularly limited, and examples thereof include a solvent-similar component that can be contained in the gel electrolyte, and various oligomer.

The separator 130 may be covered with a separator coating layer. The separator coating layer may cover both of the surfaces of the separator 130 or may cover only one of them. The separator coating layer is not particularly limited insofar as it is a member not reactive with a lithium ion and is preferably capable of firmly adhering the separator 130 to a layer adjacent to the separator 130. Such a separator coating layer is not particularly limited, and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may be obtained by adding, to the aforesaid binder, inorganic particles such as silica, alumina, titania, zirconia, magnesium oxide, magnesium hydroxide, and lithium nitrate.

The average thickness of the separator 130 is preferably 20 μm or less, more preferably 18 μm or less, and still more preferably 15 μm or less. In such a mode, the occupation volume of the separator 130 in the lithium secondary battery 100 decreases and therefore, the resulting lithium secondary battery 100 has a more improved energy density. The average thickness of the separator 130 is preferably 5 μm or more, more preferably 7 μm or more, and still more preferably 10 μm or more. In such a mode, the positive electrode 120 can be separated from the negative electrode 140 more reliably and a short circuit of the resulting battery can be suppressed further.

Use of Lithium Secondary Battery

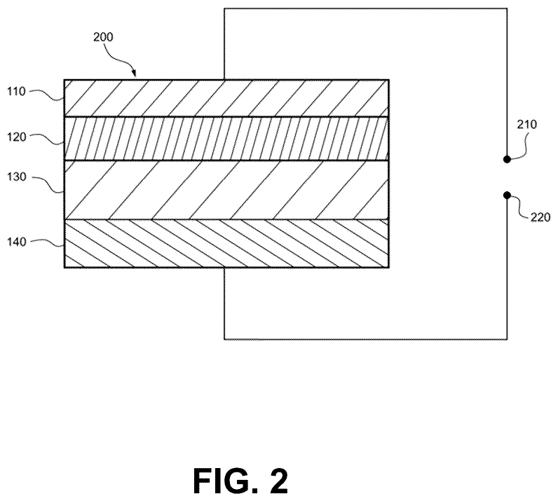

FIG. 2 shows one mode of the use of the lithium secondary battery of the present embodiment. The lithium secondary battery 200 has a positive electrode terminal 210 and a negative electrode terminal 220 for connecting the lithium secondary battery 200 to an external circuit and these terminals are bonded to a positive electrode current collector 110 and the negative electrode 140, respectively. The lithium secondary battery 200 is charged/discharged by connecting the negative electrode terminal 220 to one end of the external circuit and the positive electrode terminal 210 to the other end of the external circuit.

The lithium secondary battery 200 is charged by applying a voltage between the positive electrode terminal 210 and the negative electrode terminal 220 to cause a current flow from the negative electrode terminal 220 (negative electrode 140) to the positive electrode terminal 210 (positive electrode 120) through the external circuit. In the lithium secondary battery 200, it is presumed that the solid electrolyte interfacial layer (SEI layer) is formed on the surface of the negative electrode 140 (at the interface between the negative electrode 140 and the separator 130) by initial charging, but the lithium secondary battery 200 may not have the SEI layer. By charging the lithium secondary battery 200, the lithium metal precipitates on the interface between the negative electrode 140 and the SEI layer, on the interface between the negative electrode 140 and the separator 130, and/or on the interface between the SEI layer and the separator 130.

When the positive electrode terminal 210 and the negative electrode terminal 220 are connected to the desired charged lithium secondary battery 200 through the external circuit, the lithium secondary battery 200 is discharged. As a result, the deposition of the lithium metal generated on the negative electrode is electrolytically dissolved. When the SEI layer is formed in the lithium secondary battery 200, the deposition of lithium metal generated at least at the interface between the negative electrode 140 and the SEI layer and/or the interface between the SEI layer and the separator 130 is electrolytically dissolved.

Method of Manufacturing Lithium Secondary Battery

A method of manufacturing the lithium secondary battery 100 as shown in FIG. 1 is not particularly limited insofar as it can provide a lithium secondary battery equipped with the aforesaid structure and examples of the method include the method as follows.

The positive electrode current collector 110 and the positive electrode 120 are produced, for example, in the following manner. The aforesaid positive-electrode active material, conductive additive, and binder are mixed to obtain a positive electrode mixture. The mixing ratio may be, for example, 50 mass % or more and 99 mass % or less of the positive-electrode active material, 0.5 mass % or more and 30 mass % or less of the conductive additive, and 0.5 mass % or more and 30 mass % or less of the binder based on the total amount of the aforesaid positive electrode mixture. The positive electrode mixture thus obtained is applied to one of the surfaces of a metal foil (for example, Al foil) serving as a positive electrode current collector and having a predetermined thickness (for example, 5 μm or more and 1 mm or less), followed by press molding. The molded product thus obtained is punched into a predetermined size to obtain a positive electrode current collector 110 and a positive electrode 120.

Next, the aforesaid negative electrode material, for example, a metal foil (such as an electrolytic Cu foil) having a thickness of 1 μm or more and 1 mm or less is washed with a sulfamic-acid-containing solvent, punched into a predetermined size, ultrasonically washed with ethanol, and then dried to obtain a negative electrode 140.

Next, a separator 130 having the aforesaid structure is formed. As the separator 130, a separator produced by a conventionally known method or a commercially available one may be used.

Next, a solution obtained by mixing at least one cyclic fluorine compound described above, and the aforesaid ether co-solvent, chain-like fluorine compound, and/or non-ether co-solvent as necessary is prepared as a solvent, and the electrolyte solution is prepared by dissolving a lithium salt in this solution. The mixing ratio of the solvent and the lithium salt may be appropriately adjusted so that the content or concentration of each solvent and lithium salt in the electrolyte solution falls within the aforesaid ranges.

The positive electrode current collector 110 on which the positive electrode 120 is formed, the separator 130, and the negative electrode 140 obtained as described above are stacked in this order such that the positive electrode 120 faces the separator 130 to obtain a stacked body. The stacked body thus obtained is encapsulated, together with the electrolyte solution in a hermetically sealing container to obtain a lithium secondary battery 100. The hermetically sealing container is not particularly limited, and examples thereof include a laminate film.

### Modification Example

The aforesaid embodiments are examples for describing the present invention. They do not intend to limit the present invention only thereto and the present invention may have various modifications without departing from the gist thereof.

For example, from the lithium secondary battery 100, the separator 130 may be omitted. In this case, it is preferable to fix the positive electrode 120 and the negative electrode 140 in a state of being sufficiently separated from each other so that the positive electrode 120 and the negative electrode 140 do not come into contact with each other physically or electrically.

In the lithium secondary battery of the present embodiment, a current collector may be provided on the surface of the negative electrode placed so as to be in contact with the negative electrode. Such a current collector is not particularly limited, and examples thereof include those usable as a negative electrode material. When the lithium secondary battery has neither a positive electrode current collector nor a negative electrode current collector, the positive electrode or the negative electrode itself serves as a current collector.

On the surface of the negative electrode in the lithium secondary battery of the present embodiment, a part or all of the surface facing the separator may be coated with a coating agent. Examples of the negative electrode coating agent include benzotriazole (BTA), imidazole (IM), triazinethiol (TAS), and derivatives of these compounds. For example, after washing the aforesaid negative electrode material, the negative electrode material is immersed in a solution containing the negative electrode coating agent (for example, a solution in which the negative electrode coating agent is contained in an amount of 0.01 vol. % or more and 10 vol. % or less), and dried in the atmosphere, whereby the negative electrode material can be coated with the negative electrode coating agent. It is presumed that the coating of the aforesaid compound suppresses non-uniform deposition of lithium metal on the surface of the negative electrode and suppresses the growth of a lithium metal deposited on the negative electrode into dendrite form.

The lithium secondary battery of the present embodiment may have, at the positive electrode current collector and/or negative electrode, a terminal for connecting it to an external circuit. For example, a metal terminal (for example, Al, Ni, or the like) having a length of 10 μm or more and 1 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total volume or total mass is high. It is preferably 700 Wh/L or more or 300 Wh/kg or more, more preferably 800 Wh/L or more or 350 Wh/kg or more, and still more preferably 900 Wh/L or more or 400 Wh/kg or more.

The term “having an excellent cycle characteristic” as used herein means that a decreasing ratio of the capacity of a battery is small before and after the expected number of charging/discharging cycles in ordinary use. Described specifically, it means that when a first discharge capacity after the initial charging/discharging and a capacity after the number of charging/discharging cycles expected in ordinary use are compared, the capacity after charging/discharging cycles has hardly decreased compared with the first discharge capacity after the initial charging/discharging. The “number expected in ordinary use” varies depending on the usage of the lithium secondary battery and it is, for example, 30 times, 50 times, 70 times, 100 times, 300 times, or 500 times. The term “capacity after charging/discharging cycles hardly decreased compared with the first discharge capacity after the initial charging/discharging” means, though differing depending on the usage of the lithium secondary battery, that the capacity after charging/discharging cycles is, for example, 60% or more, 65% or more, 70% or more, 75% or more, 80% or more, or 85% or more, each in the first discharge capacity after the initial charging/discharging.

A numerical range described as a preferred range or the like as used herein may be replaced with a numerical range obtained by arbitrarily combining the described upper limit value and lower limit value. For example, in a case where a certain parameter is preferably 50 or more and more preferably 60 or more, and is preferably 100 or less and more preferably 90 or less, the parameter may be any of 50 or more and 100 or less, 50 or more and 90 or less, 60 or more and 100 or less, or 60 or more and 90 or less.

### EXAMPLES

The present invention will hereinafter be described in detail by Examples and Comparative Examples. The present invention is not limited by the following test examples.

### Example 1

A lithium secondary battery of Example 1 was formed as follows.

Formation of Negative Electrode

First, an 8 μm electrolytic Cu foil was washed with a solvent containing sulfamic acid, punched to a predetermined size (45 mm×45 mm), washed ultrasonically with ethanol, and then dried to obtain a Cu foil, which was used as a negative electrode.

Formation of Positive Electrode

A positive electrode was formed. A mixture of 96 parts by mass LiNi0.85Co0.12Al0.0302 positive-electrode active material, 2 parts by mass carbon black conductive additive, and 2 parts by mass polyvinylidene fluoride (PVDF) binder was applied to one surface of 12 μm-thick Al foil and press-molded. The molded product thus obtained was punched to a predetermined size (40 mm×40 mm) to obtain a positive electrode which had a positive electrode current collector on one surface.

Formation of Separator

As a separator, that obtained by coating 2-μm polyvinylidene fluoride (PVDF) on both sides of a 12-μm polyethylene microporous membrane and having a predetermined size (50 mm×50 mm) was formed.

Preparation of Electrolyte Solution

An electrolyte solution was prepared as follows. Both solvents of 1,1,2,2,3,3,4-heptafluorocyclopentane and 1,2-dimethoxyethane were mixed with an amount of 80 vol. % of 1,1,2,2,3,3,4-heptafluorocyclopentane and 20 vol. % of 1,2-dimethoxyethane. An electrolyte solution was obtained by dissolving LiN(SO2F)2 in the resulting mixed solution so as to have a molar concentration of 1.0 M.

Assembly of Battery

The positive electrode current collector on which the positive electrode was formed, the separator, and the negative electrode obtained as described above were stacked in this order such that the positive electrode faced the separator to obtain a stacked body. Further, a 100-μm Al terminal and 100-μm Ni terminal were bonded to the positive electrode current collector and the negative electrode, respectively by ultrasonic welding and then the bonded body was inserted into a laminate-film outer container. Then, the electrolyte solution prepared as described above was poured in the outer container. The resulting outer container was hermetically sealed to obtain a lithium secondary battery.

### Examples 2 to 14

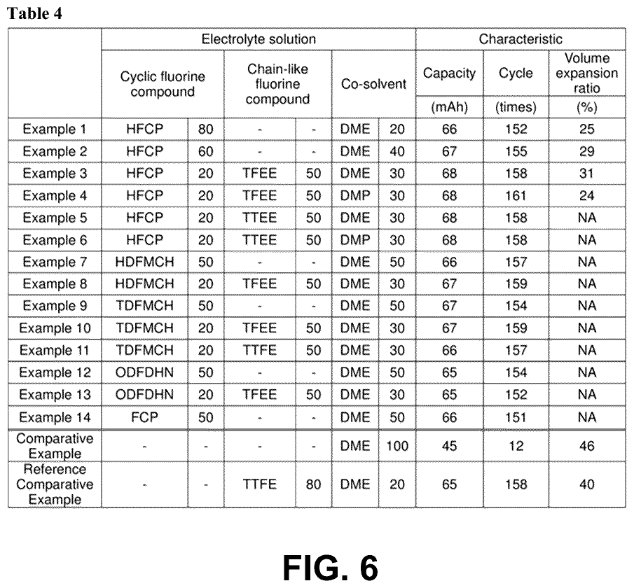

Lithium secondary batteries were obtained in the same manner as in Example 1, except that the electrolyte solutions were prepared using the solvents described in Table 4 of FIG. 6.

### Comparative Example and Reference Comparative Example

Lithium secondary batteries were obtained in the same manner as in Example 1, except that the electrolyte solutions were prepared using the solvents described in FIG. 6. Comparative Example relates to a lithium secondary battery that does not contain the cyclic fluorine compound and contains only the ether co-solvent, and Reference Comparative Example relates to a lithium secondary battery that contains the ether co-solvent and the chain-like fluorine compound.

In FIG. 6, “HFCP” indicates 1,1,2,2,3,3,4-heptafluorocyclopentane, “HDFMCH” indicates hexadecafluoro(1,3-dimethylcyclohexane), “TDFMCH” indicates tetradecafluoromethylcyclohexane, “ODFDHN” indicates octadecafluorodecahydronaphthalene, and “FCP” indicates fluorocyclopentane. In addition, “TTFE” indicates 1,1,2,2-tetrafluoroethyl-2,2,3,3-tetrafluoropropyl ether, and “TFEE” indicates 1,1,2,2-tetrafluoroethyl-2,2,2-trifluoroethyl ether. Further, “DME” indicates 1,2-dimethoxyethane, and “DMP” indicates 1,2-dimethoxypropane.

In FIG. 6, each solvent is classified as any of the cyclic fluorine compound, the chain-like fluorine compound, or the ether co-solvent with the aforesaid definitions. In addition, in FIG. 6, in the column to the right of each solvent, the content with respect to the total amount of the solvent is described in units of vol. %. For example, in FIG. 6, it is described that Example 1 contained 80 vol. % of HFCP and 20 vol. % of DME. All Examples, Comparative Example, and Reference Comparative Example contained 1.0 M of LiN(SO2F)2 as the electrolyte.

Evaluation of Cycle Characteristic

The cycle characteristic of each of the lithium secondary batteries formed in Examples and Comparative Examples was evaluated as follows.

The formed lithium secondary battery was CC-charged at 3.2 mA until the voltage reached 4.2 V (initial charge), and then CC-discharged at 3.2 mA until the voltage reached 3.0 V (which will hereinafter be called “initial discharge”). Next, a cycle of CC-charging at 13.6 mA until the voltage reached 4.2 V and then CC-discharging at 20.4 mA until the voltage reached 3.0 V was repeated at a temperature of 25° C. FIG. 6 shows the capacity (“initial capacity”; described as “Capacity” in the table) obtained from the initial discharge for each example. For the examples, the number of cycles (described as “Cycle” in the table) when the discharge capacity reached 80% of the initial capacity is shown in FIG. 6.

Measurement of Volume Expansion Ratio

The volume expansion ratio of the lithium secondary batteries formed in Examples and Comparative Example was evaluated as follows.

For each example, the thickness of the cell immediately after the production and the thickness of the cell after 100th charging after 99 times of the charging/discharging cycles were each measured using a microgauge, and the volume expansion ratio accompanying charging/discharging was measured.

FIG. 6 shows the volume expansion ratio of the cell after 100th charging with respect to the cell immediately after the production (expansion proportion of the cell after 100th charging with respect to the thickness of the cell immediately after the production) as “Volume expansion ratio (%)”.

In FIG. 6, “−” means that the corresponding component was not included, and “NA” means that the volume expansion ratio was not measured.

It is apparent from FIG. 6 that the batteries of Examples 1 to 14 using the electrolyte solution containing the aforesaid cyclic fluorine compound have excellent cycle characteristic compared with Comparative Example which is different from the aforesaid Examples. In addition, when comparing Reference Comparative Example and Examples 1 to 4, it is apparent that the volume expansion ratios of Examples 1 to 4 are low, and the lithium secondary battery of the present embodiment has more excellent safety.

### INDUSTRIAL APPLICABILITY

The lithium secondary battery of the present invention has a high energy density and an excellent cycle characteristic so that it has industrial applicability as a power storage device to be used for various uses.

What is claimed is:

1. A lithium secondary battery, comprising:
a positive electrode;
a negative electrode not having a negative-electrode active material; and
an electrolyte solution,
wherein the electrolyte solution contains
a lithium salt and
a cyclic fluorine compound having a cyclic hydrocarbon skeleton in which at least one hydrogen atom is substituted with a fluorine atom.

2. The lithium secondary battery according to claim 1, wherein the cyclic fluorine compound has polarity.

3. The lithium secondary battery according to claim 1, wherein, in the cyclic fluorine compound, a ratio (F/(F+H)) of a number (F) of fluorine atoms to a total number (F+H) of fluorine atoms and hydrogen atoms is 0.20 or more and 1.0 or less.

4. The lithium secondary battery according to any one of claim 1, wherein a number of carbon atoms constituting the cyclic hydrocarbon skeleton is 4 or more and 15 or fewer.

5. The lithium secondary battery according to any one of claim 1, wherein the electrolyte solution contains LiN(SO2F)2 as the lithium salt.

6. The lithium secondary battery according to any one of claim 1, wherein a content of the cyclic fluorine compound is 10 vol. % or more and 90 vol. % or less based on a total amount of solvent components in the electrolyte solution.

7. The lithium secondary battery according to any one of claim 1, wherein the electrolyte solution further contains an ether compound not having a fluorine atom.

8. The lithium secondary battery according to claim 7, wherein the ether compound is a compound that includes 2 or more and 5 or fewer ether bonds.

9. The lithium secondary battery according to claim 7, wherein a content of the ether compound is 10 vol. % or more and 70 vol. % or less based on a total amount of solvent components in the electrolyte solution.

10. The lithium secondary battery according to any one of claim 1, wherein the electrolyte solution further contains a chain-like fluorine compound having at least one of a monovalent group represented by Formula (A) or a monovalent group represented by Formula (B), 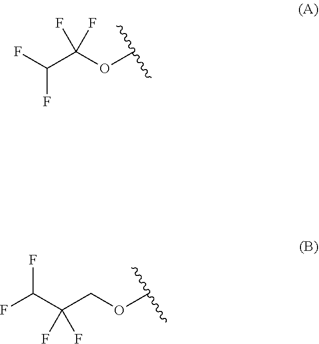
in the formulae, a wavy line represents a bonding site in the monovalent group).

11. The lithium secondary battery according to claim 10, wherein a content of the chain-like fluorine compound is 10 vol. % or more and 85 vol. % or less based on a total amount of solvent components in the electrolyte solution.

12. The lithium secondary battery according to any one of claim 1, wherein the cyclic hydrocarbon skeleton is a saturated cyclic hydrocarbon skeleton.

13. The lithium secondary battery according to any one of claim 1,
wherein, in the cyclic fluorine compound, a ratio (F/(F+H)) of a number (F) of fluorine atoms to a total number (F+H) of fluorine atoms and hydrogen atoms is 0.7 or more and 1.0 or less, and
a number of carbon atoms constituting the cyclic hydrocarbon skeleton is 5 or 6.
